(19) United States
(12) Patent Application Publication
(10) Pub. No.: US 2015/0179169 A1
(43) Pub. Date: Jun. 25, 2015

(54) Speech Recognition By Post Processing Using Phonetic and Semantic Information

(71) Applicants: Vijay George John, Austin, TX (US); Thomas John, Austin, TX (US)

(72) Inventors: Vijay George John, Austin, TX (US); Thomas John, Austin, TX (US)

(21) Appl. No.: 14/134,710

(22) Filed: Dec. 19, 2013

(51) Int. Cl. G10L 15/18

(52) U.S. Cl. CPC G10L 15/1815

(57) ABSTRACT

A system is described for improving results of Automatic Speech Recognition (ASR) systems. ASR's typically match patterns of incoming sounds to phonemes associated with sounds in a specified language, then associates phonemes with words. ASR's typically consider combinations of up to three phonemes and up to three words. The limitation to small combinations of phonemes and words is one source of errors in ASR's. The invention described here post processes the output from ASR's. In one embodiment, the method forms long combinations of phonemes and words to improve ASR results. In another embodiment, the method detects errors by finding inconsistencies in the ASR's output and then corrects these errors. Other embodiments correct errors that are phonetically close to the correct words, determines the right list of words from a large expected list of sentences, and further improves recognition where word errors are phonetically close to the correct words.

### FIELD OF THE INVENTION

The present invention relates to speech recognition, and more particularly to methods of improving results by processing output from speech recognizers to improve recognition and reduce errors. The invention applies to all written natural human languages that for which working speech recognizers exist.

### BACKGROUND

Automatic speech recognition (ASR) technology has seen several decades of development. More recently, there has been increased availability and use of hand-held mobile devices with speech recognition capabilities. As the devices have become smaller, entering information through typing has become more difficult. However, availability of popular speech recognition applications has increased the awareness of ASR errors.

While ASR methods are most convenient for entering information into small devices, they are also generally not as accurate as typing. ASR developers have created various ways to handle this, however even the most modern systems can make serious mistakes (For example, there is a popular term “rickrolling” to describe the tendency of Apple's ASR product “Siri” to recognize the common query “what is today going to be like” by sending users to the Wikipedia page of a British singer named Rick Astley.)

We have analyzed speech recognition errors for several languages using Google's web-based ASR. This shows that similar errors occur in many widely spoken languages.

ASR technology is based on a large number of discoveries. FIG. 1 shows the components of a simple ASR system. Each of the parts of this system corresponds to various technologies.

One way to think of an ASR solution is to consider it as a processing pipeline. This is the view taken for example with a popular open source solution called Sphinx developed at Carnegie-Mellon University. The processing pipeline can be considered as a way to convert spoken sound waves into text.

This pipeline goes through several steps. A microphone converts speech waves to electrical signals. These analog electrical signals are usually sent through a digital signal processor to obtain a spectrum. Earlier systems obtained a Fourier spectrum, but later it was found better to obtain a cepstrum that is obtained through similar methods. After the signal is converted to a cepstrum, it is matched against stored patterns of cepstra from several training examples. This matching process is generally based on some probabilistic methods.

The matching produces several likely matches of portions of the spoken sound to phonemes or parts of phonemes. These are then analyzed, again based on probabilistic methods, to determine the most likely sequence of words that were spoken. This information is output as text.

Even though details of phonemes and words differ between languages, the above processing pipeline may generally be used for ASR systems for any human language.

In some ASR systems, the output from the speech recognition can be obtained in the form of a sequence of phonemes. In most ASR systems, usually called “speech to text systems”, the output is in the form of words in a specific written language (such as English, German, Russian etc).

ASR system errors can be caused by any of the components in the pipeline. However, assuming they all work well, most ASR systems in use today consider patterns of phonemes or words that consist of just a few units. For phonemes, generally triphones or combinations of three phoneme are used whereas for words, ASR's generally consider trigrams or combinations three words. However, languages contain both sound and word formation patterns that are not contained within such short units. This results in incorrectly recognized phrases that make sense in short combinations but not as a whole. For example a phrase “tuck the sheet under the edge of the mat” was incorrectly recognized by a recognizer as “tuck the sheet under the age of the night.” The four word combination “age of the night” may occur in the language just like the combination “edge of the mat,” but “sheet under the age of the night” does not commonly occur in English.

The output from an ASR system may contain these and other types of errors. This output can be passed through a post-processor to correct some obvious errors. Post-processing generally uses some extra information to improve recognition results. This invention does not use any information internal to the ASR but uses phoneme and word combination properties of the recognized language.

There are some other inventions related to post-processing ASR output.

Kim U.S. Patent No. 20060136207 uses a system to decide on the possible errors in recognition and rejects or enhances the results based on some measurements including durations of utterances. This method determines incorrect recognition of the speech “based on feature data such as an anti-model log likelihood ratio (LLR) score, N-best LLR score, combination of LLR score and word duration which are outputted from a search unit of a hidden Markov model (HMM) speech recognizer.”

Shaw U.S. Patent No. 20130054242 also enhances recognition results by “determining consistencies of one or more parameters of component sounds of the spoken utterance, wherein the parameters are selected from the group consisting of duration, energy, and pitch . . . ”

Laperdon U.S. Patent No. 20110004473 works on the speech recognition results by “activating an audio analysis engine which receives the acoustic feature to validate the result and obtain an enhanced result.”

Brandow U.S. Pat. No. 6,064,957 improves recognition by comparing the actual output from an ASR with the intended output to learn rules about required to correct the actual output and to subsequently apply the same rules to new outputs from the ASR.

The present invention applies to written human languages for which ASR's exist. If the invention is applied to output from ASR systems in the form of phonemes, then it requires a way to decompose words in a language to phonemes. For some widely spoken languages such as English, there are phonetic dictionaries that relate words to phonemes. For other languages, it is possible to decompose words using a previously published method (see Vijay John, Phonetic Decomposition for Speech Recognition of Lesser-Studied Languages, Proceeding of the ACM 2009 international workshop on Intercultural collaboration, Palo Alto, http://portal.acm.org/citation.cfm?id=1499269.)

### SUMMARY

The present invention describes a method and system to correct some speech recognition errors. Speech recognition systems rely on a large amount of training data to determine patterns associated with speech sounds or phonemes. However, they generally do not consider long sequences of phonemes or words in patterns partly due to the fact that it is difficult to store all such sequences. The present invention overcomes this limitation by finding words that best fit long sequences of phonemes. Another part of the invention finds combinations of words that are consistent with common language use. This part also uses long combinations of words that are consistent with the recognized language. Thus the present invention overcomes some limitations of ASR's and obtains more accurate speech recognition results from post processing the output produced by ASR systems.

There are several embodiments of this invention that applies in various situations involving ASR's and applications using ASR's.

One embodiment of the invention applies to phonemes that are recognized by ASR systems. Not all ASR systems produce phoneme output.

Another embodiment of the invention improves results from ASR systems that outputs sequences of words. Most ASR systems work this way.

A third embodiment of the invention improves results from ASR systems that outputs words which may contain errors that may include words that are phonetically close to the intended spoken words.

A fourth embodiment of the invention applies to results from ASR systems where the correctly recognized sentence is expected to come from a large list of sentences. In this embodiment of the invention, the intended sentence is reconstructed from the partially correct sequence of words produced by the ASR.

A fifth embodiment of the invention applies to results from ASR systems that are as in the fourth embodiment but where many of the incorrectly recognized words are phonetically similar to the correct words. In this embodiment, the intended sentence is reconstructed from a combination of phonetic and word sequence properties of the intended sentences.

### BRIEF DESCRIPTION OF DRAWINGS

A better understanding of the present invention can be obtained from the following detailed description in conjunction with the following drawings, in which:

FIG. 1 is the labeled picture of how the post-processor ties in with a standard ASR diagram

FIG. 2 shows two ways a specific sequence of phonemes may be converted to words. The top part of the figure shows how the phonemes should ideally be aligned with the phonemes of two words. The bottom part shows how other words may also partially match the same phonemes.

FIG. 3 illustrates the main modules of the post-processor described here. The modules indicated in this figure are explained in greater detail in later figures.

FIG. 4 shows the way words can be decomposed into phones by looking up this decomposition in a phonetic dictionary. In situations where there is no such dictionary, this method is used to obtain phonetic decompositions of words.

FIG. 5 illustrates the method for post-processing that finds the best candidates for filling intervals of phonemes in the output from the recognizer. This shows the way it is done, by incrementally combining intervals while maintaining consistency.

FIG. 6 shows how errors are detected by checking a sequence of words against a large collection of documents containing text from the language of the ASR.

FIG. 7 shows how inconsistencies are detected in sequences of words from either an ASR directly or after processing phonemes as above. Then it attempts to correct inconsistent sequences of words.

FIG. 8 illustrates another embodiment of the invention where ASR output in words is converted to phoneme output to create word matches and subsequently corrected.

FIG. 9 shows another embodiment of the invention where the ASR should recognize one of many possible user inputs and where the best match is made using incremental search of a sequence of words.

FIG. 10 illustrates another embodiment of the invention where the ASR should recognize one of many possible user inputs and produces words that may not be correct but are phonetically close to the intended words, where the best match is made using incremental search of a sequence of phonemes.

### DETAILED DESCRIPTION OF THE DRAWINGS

Described below is a method for improving the accuracy of Automatic Speech Recognition systems (ASR). For the purposes of explanation, numerous specific details are described throughout this description to provide a thorough understanding of the present invention. It will be apparent, however, to one skilled in the art that the present invention may be practiced without some of these specific details.

Note that in this detailed description, references to “one embodiment” or “an embodiment” mean that the feature being referred to is included in at least one embodiment of the invention. Moreover, separate references to “one embodiment” in the description do not necessarily refer to the same embodiment, however, neither are such embodiments mutually exclusive, unless so stated, and except as will be readily apparent to those skilled in the art. Thus, the invention can include any variety of combinations and/or integration of the embodiments described here.

### Example of ASR Architecture

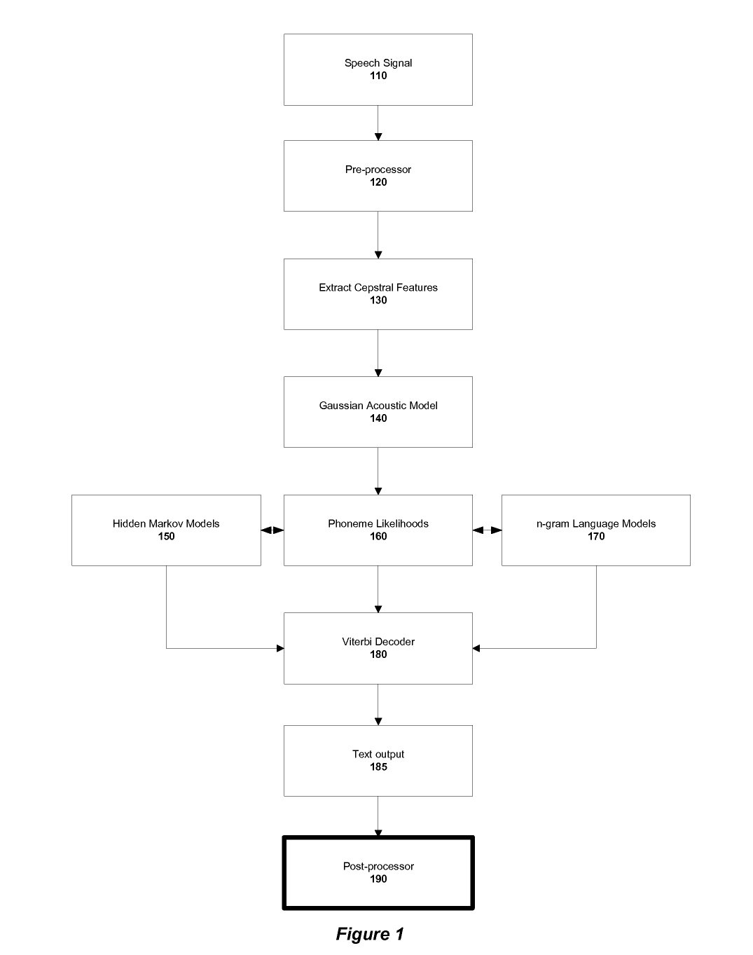

FIG. 1 shows a simplified architecture of an ASR system. As shown here, an ASR system contains a number of components that work together to convert an incoming set of sound waves into phonemes and then into words of text. The incoming sound waves (not shown) are converted into electronic speech signals 110. This signal is usually pre-processed 120. This may involve emphasizing some parts of the signal or suppressing noise. After this stage, the signals are sent through one or more stages of signal processing using a combination of hardware and software methods, resulting 130 in the computation of cepstra (Cepstra can be thought of as the “spectrum of the log of the spectrum” of the incoming signals). Since there is a lot of variation in the way different speakers make the same sound in different situations, the information at this stage is matched with a Gaussian acoustic model 140. This model compares patterns in the cepstra with previously seen patterns using some probability distributions that are generally assumed to be Gaussian or Normal distributions. The result is some information about the likelihood that some parts of the cepstra are related to particular phonemes 150. Usually Hidden Markov models 160 are used both in determining the likelihood of phonemes and the likelihoods of words being related to phones that are stored in groups of one to three words in n-gram language models 170. From the likelihoods a decoder 180 determines the likely sequence of words that were spoken which is then output as text 185. This text may then be post-processed mainly for the purpose of formatting the output.

The present invention relates the post-processing stage 190 where it enhances the recognition results without using internal information from the ASR stages up to stage 185. Some ASR systems can optionally output their best guess about the stream of recognized phonemes. In other ASR systems, the output consists of text, but this can be converted into a sequence of phonemes that is related to, but not necessarily the same as, the phonemes that were originally recognized by the ASR. In other embodiments, the present invention applies to ASR and its applications in various situations.

### Words and Phonemes

Words are written using characters. They are spoken by putting together various sound units. Each individual sound unit is a phoneme. For each word, there are one or more ways to say it. Each way of saying the word corresponds to a sequence of phonemes.

The phonemes that occur in world languages are represented by the International Phonetic Alphabet. This uses various special symbols and is therefore not convenient for computer programming. There is a way to write the phonetic symbols using several Roman letters. For English phonemes, a system called ARPAbet includes the ways to do this. The task of converting all of the IPA symbols into sequences of Roman letters only involves finding unique sequences of letters. This was used to obtain phonetic decompositions of words in several languages.

### Errors in Converting Phonemes to Words

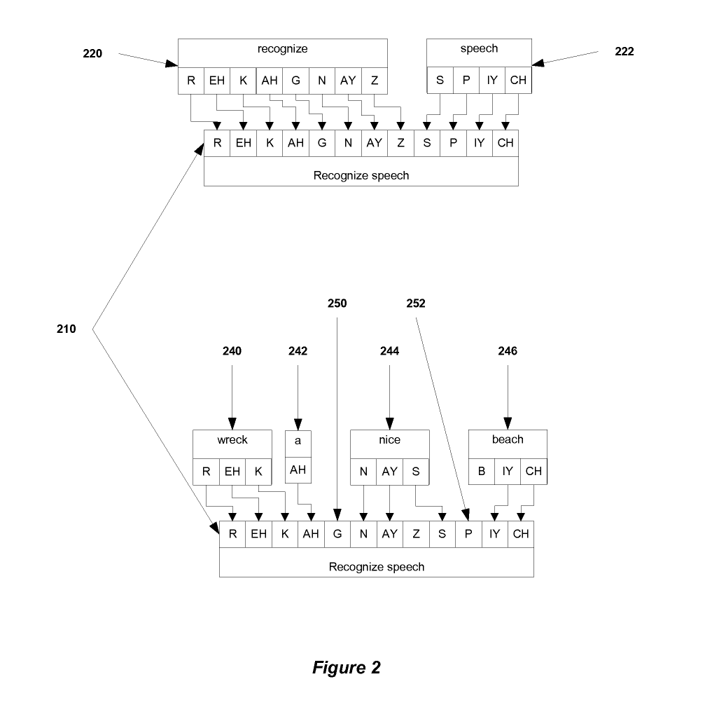

FIG. 2 shows two examples of the ways that a sequence of phonemes may be converted to a sequence of English words. The top part of the picture shows an ideal conversion while the bottom part shows another conversion that could also occur. (The example is shown as only an illustration that is often used to describe ASR errors. The present invention is neither limited to nor specifically associated with this example.) The figure shows the phonetic decomposition of the phrase “recognize speech.” indicated as 210. The phonemes that are shown are from a phonetic dictionary called CMUDict which uses the ARPAbet notation. This sequence of phonemes would be produced by an ASR system if the phrase was perfectly recognized.

Note that the phoneme sequence shown in 210 does not contain a break between the two words in the phrase “recognize speech.” This is typical of the phoneme output from ASR systems. If the pause between the two words is long, the phoneme sequence may contain a silence phoneme in between the two words. But typically speakers do not pause for any significant amount of time between words.

If there is no indication of the word boundaries, then words may be constructed out of the phoneme sequence in different ways. In the top part of the picture, the phonemes are used to create the words “recognize” shown as 220 and “speech” (222) which fits the phoneme sequence perfectly. The bottom part of the picture shows a situation where the words “wreck” (240) “a” (242) “nice” (244) and “beach” (246) are used to fit the phoneme sequence. This is not a perfect fit since it leaves out the G (250), Z and P (252) phonemes in the phoneme sequence. In addition, there is no phone in the sequence that matches the B in “beach”.

When a phrase is spoken to an ASR system, there is no guarantee that the phonemes in the phrase will be perfectly recognized. Thus, the phoneme sequence obtained as a result of speaking the phrase “recognize speech” may not be the phonemes shown in FIG. 2. This makes it harder to choose between the two possible word combinations shown in this figure.

In a typical ASR system, there is a chain of probabilities that are used to determine the most likely choice for one phoneme or word based on the context of a few previous phonemes or words. In the example shown in the figure, the wrong choice of “wreck” prevents the system from choosing “recognize”. This in turn can cause “speech” not be chosen eventually.

### Modules of the Invention

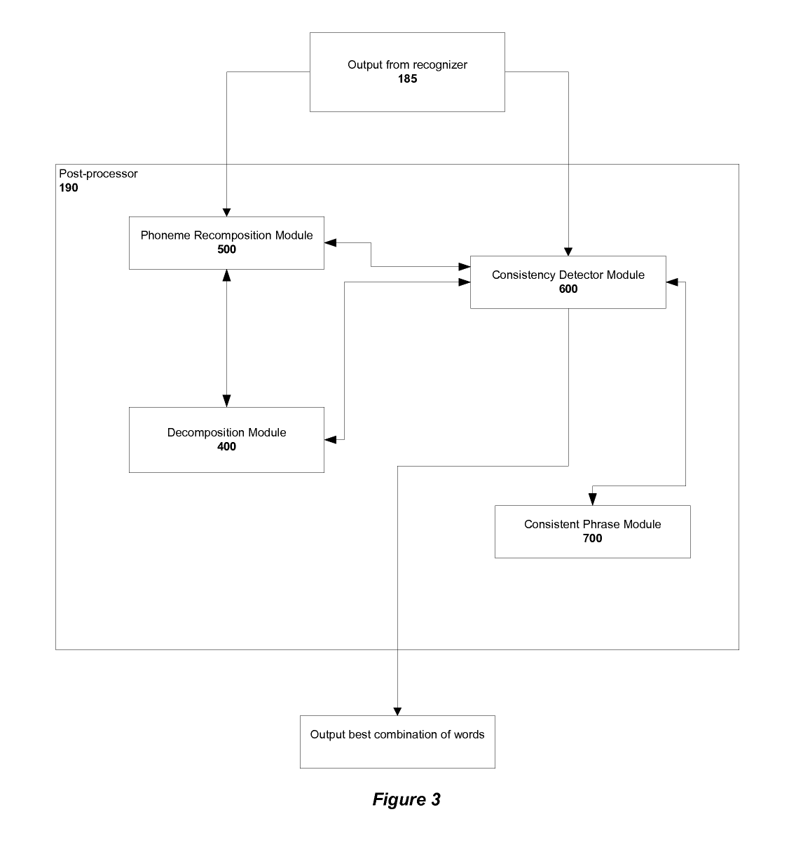

FIG. 3 shows the main post-processing modules of the present invention. The output 185 from an ASR provides the input to the post-processor.

The output 185 can be in the form of phonemes or in the form of words. If the output is in the form of phonemes, then it is passed to the Phoneme Recomposition Module 500. This module utilizes a previously disclosed Decomposition Module 400. The Recomposition Module 500 creates sequences of words that can then processed through a Consistency Detector Module 600.

If the output 185 is in the form of words, it passes directly to the Consistency Detector Module 600. The Consistency Detector Module utilizes a Consistent Phrase Module 700.

The Consistent Phrase Module 700 produces sequences of words that, after checking through the Consistency Detector Module 600 are passed to the output from the post-processor.

While some connections between different modules are shown here, there are different embodiments of the invention that may alter the flow described above. For example, in one embodiment, the output from the ASR 185 is in the form of words, but it is converted to phonemes using the Decomposition Module 400 and then processed as a sequence of phonemes to be processed by the Phoneme Decomposition Module 500.

Decomposing Words into Phonemes

Some embodiments of the present invention starts by obtaining phonetic decompositions of words in a language. For some languages such as English, this phonetic decomposition can be obtained from a dictionary such as CMUDict from Carnegie Mellon University. For many other widely spoken languages, it is possible to obtain phonetic decompositions through a previously published method. Although this method has been published, some embodiments of the present invention needs to use this method. Therefore some details are given below to help with implementation of these embodiments.

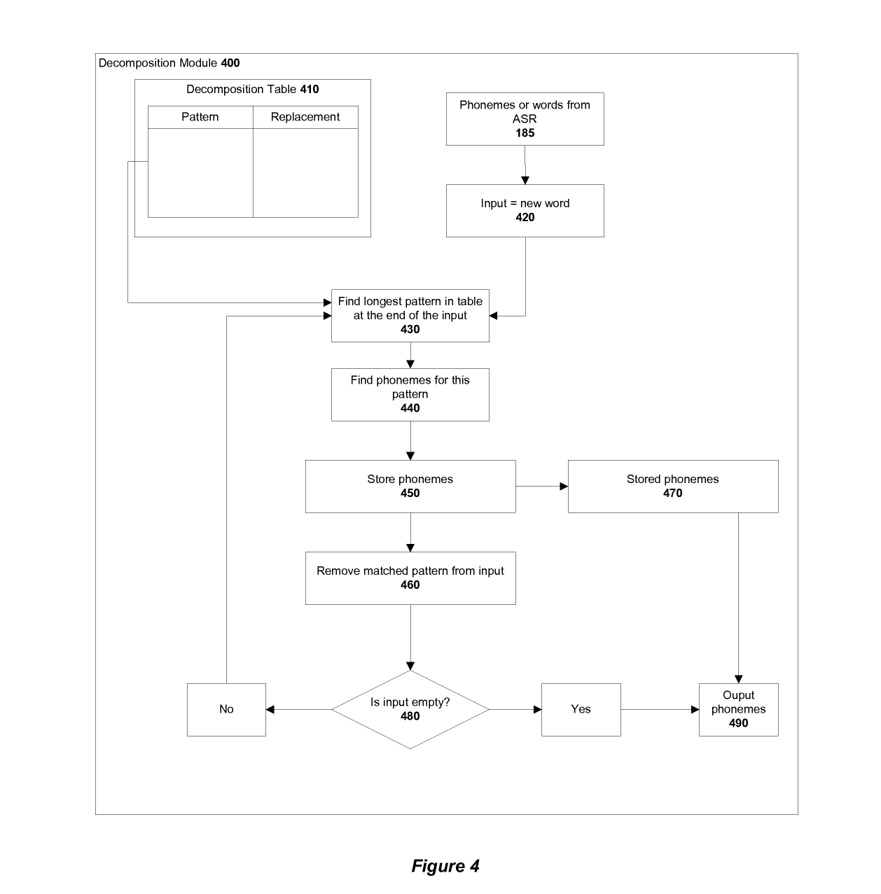

FIG. 4 describes this method. Although this published procedure is used by the present invention, it is not part of the invention and is included here as background information. This method is used to obtain decompositions of words in FIG. 3.

The decomposition method has been used on a wide variety of languages [Langs]. For each such language, a decomposition table is used to create decompositions of words based on the letters in the word. The table for each language utilizes one way to write the language using Roman letters. The table relates certain patterns of Roman letters to sequences of one or more phonemes for words in that language. (This process largely relies on knowledge of the language).

The decomposition procedure starts by considering each new word 420. It finds the longest match between the letter patterns at the end of the word (430). After finding this pattern, 440 finds the corresponding sequence of phonemes from the table (410). It stores this pattern (450) in a sequence (470) and removes the matched pattern of letters (460). The remaining string is now treated as input and sent back to 430. When there is nothing remaining (480) it retrieves the stored pattern (470) and outputs the decomposition (490).

### Creating Compositions of Phonemes

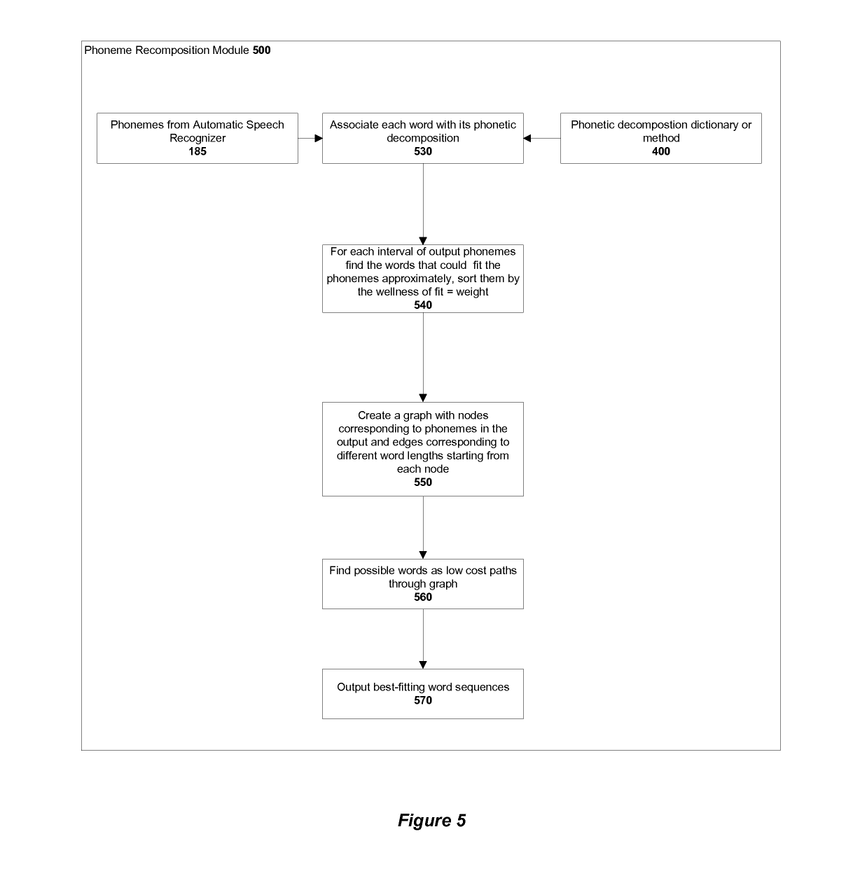

FIG. 5 shows the method of the invention for converting phonemes into words. The input to this method is the sequence of phonemes from an ASR 510. This is combined with a way to obtain phonetic decompositions 520. The words in the language are thus associated with their phonetic decompositions 530.

The output sequence of phonemes may contain some phonemes in common with the phonetic decompositions 530. But in some cases, there may be only a few phonemes from a word that occur in the sequence 510. In some other cases, the phonemes that do occur in 530 are far apart in 510. The best fitting words may be found where a sequence of consecutive phonemes in 510 occur within the phonetic decomposition of those words.

A consecutive sequence of phonemes from 510 is called an interval of output phonemes. If there are n phonemes in the output sequence then there are roughly n times n intervals of phones in the output sequence. For each of these intervals, and for each of the words in the language, there is a possibility that the word may fit some phone within that interval. The wellness of this fit is determined in 540.

As an example, consider the output from one ASR as it tries to recognize an Arabic (Modern Standard Arabic) expression “warritxab bilyaabis”. The output in this case was the sequence of phonemes

### W AX RR RR I TP AX B ITD N Y AEL Q IS

The two words making up the expression have decompositions
W AX RR RR I TP AX B for “warritxab”
and
B I L Y AEL B I S for “bilyaabis”.
(The phonemes shown here are written using Roman letters.)

The output phoneme sequence matches the first word fairly well, but it does not match the second word too well. There is however two pairs of phones Y AEL and I S that are in both the second word and the output phoneme sequence. Thus, the match between the phonemes starting with B in the second word is not too good, but it still has some things in common. Note that although the first word ends with the phoneme B and the second word starts with the phoneme B, there is only one B in the output.

The method considers “bilyaabis” as one possibility for filling the interval of phonemes starting with B and ending with S. It will check for other words which may fit the interval in other ways. All of these candidates are collected into a list and associated with this interval 540. For each word that may fit partially the method assesses some wellness of fit. One way to do this assessment is using edit distance. Other assessment methods could consider contiguous sub sequences of output phonemes in the phonetic decomposition sequence of the word as well as the locations of missing phonemes from either sequence. Based on the selected assessment, the method creates a prioritized list of words that could fit the given interval. This procedure is done for all of the intervals of phonemes in the output. For each interval, this procedure determines the wellness of fit for the best fit. This is called the weight of the interval.

The next step is to construct a weighted graph of vertices and edges. The vertices (also called nodes) of the graph are the positions of each phoneme in the output. The edges of the graph are intervals within the sequence of phones. This graph is created at step 550.

If there are n phonemes, then there are n vertices or nodes. Suppose i and j are values between 1 and n, i is less than n. Then both i and j can be considered as nodes. The sequence of phonemes from the output starting at i and ending at j can be considered as an interval. This interval has an associated list of words as well as measurements of how well they match. The edges of the graph are weighted. The weight of an edge from node i to node j is the length of the interval from i to j.

For each language the method finds the maximum length k of words to be considered. For each node i, the graph has an edge to i+h for all positive integers h not greater than k.

In one embodiment, the method uses a standard algorithm, such as D'jikstra's minimum cost path method, to find a path from the starting node 1 to the ending node n. This path will consist of a selection of intervals going from the first node to the a-th node where a is greater than 1, then from there to some b-th node where b is greater than a and so forth until it reaches the n-th node. For each of the edges used in this path, the method selects one or more words as the possible recognition result for the interval corresponding to the edge. The method then outputs one or more such paths at stage 560.

The method has an alternate embodiment where instead of the minimum-cost path, it finds several low-cost paths starting with the lowest cost path and finding new paths up to some maximum number of paths. All of these paths then have associated words that are output as alternate sequences of recognized words at 560.

### Correcting Incomplete Phrases

The method described here creates combinations of words that occur in a specified language. These combinations do not have to be sentences. They also do not need to conform to grammatical rules of the language.

### Error Estimation

One method of estimating errors is to consider sum of three types of errors. The three types are insertion errors, deletion errors and substitution errors. An insertion error is where a phoneme is incorrectly inserted into an otherwise correct sequence of phonemes. Deletion errors are where a phoneme is deleted from an otherwise correct sequence of phonemes. A substitution (or replacement) error is one where a phoneme is incorrectly replaced by another. Another estimate considers a replacement simply as a deletion followed by an insertion, thus counting a substitution error as two errors.

Alternate embodiments of error estimation may utilize other combinations of insertions, deletions and substitutions. The method described here can be applied regardless of the particular combination used to estimate errors.

### Non-Roman Characters

The method described here applies even if the ASR produces phonemes written using non-Roman characters. The method already works with multiple languages written using ARPABET sequences of Roman letters. If the ASR output is written using other characters, the method first converts the phonemes written using non-Roman letters into unique sequences of phonemes written using Roman characters.

### Tonal Languages

The method applies to tonal languages. For example the method applies to Mandarin Chinese, which uses tones. The method represents different tones of the same sound using different phonemes, written user ARPABET. Different tones are indicated using numbers so that phonemes involving different tones are indicated by different sequences of both letters and numbers.

### ASR Output in Multiple Languages

The method applies to ASR's that output phonemes that belong to more than one language. To handle this situation, the method uses lists of words in all the languages used in an ASR output. Since the output is in the form of ARPABET phonemes for all the languages, the method does not distinguish between different languages after processing the decompositions of all the different languages using module 400.

### Detecting and Correcting Word Sequences

Some ASR systems can output sequences of phonemes. Almost all ASR systems output sequences of words. The first part of this invention describes a way to convert sequences of phonemes from a given language into a sequence of words from that language.

The second part of the invention detects and corrects errors in sequences of words whether they are obtained directly from an ASR system or from the process described in the first part of the invention.

The second part of the invention has a detection method and a correction method.

The detection method determines whether a sequence of words may contain errors.

The correction part corrects sequences that are detected to contain errors.

### Detection of Errors

Consider the recognition of the English phrase “tuck the sheet under the edge of the mat.” This may be recognized incorrectly as “tuck the sheet under the age of the night.” The recognized sequence of words does not “make sense.” The detection method provides a way to determine when a sequence of words does not make sense.

The method of this invention uses a large collection of text in the language of the recognizer to determine whether a sequences of words make sense. In this case, the sequence of words “age of the night” or “edge of the mat” both make sense. An ASR system may recognize various combinations of words here such as “sheet under the” and “tuck the sheet”. However “under the age of the night” or “sheet under the age of the night” may not occur naturally in a collection of English texts.

One way to test this is to use a search engine which indexes a lot of text. However search engines generally do not store exact phrases of many words thus this is not a totally reliable method.

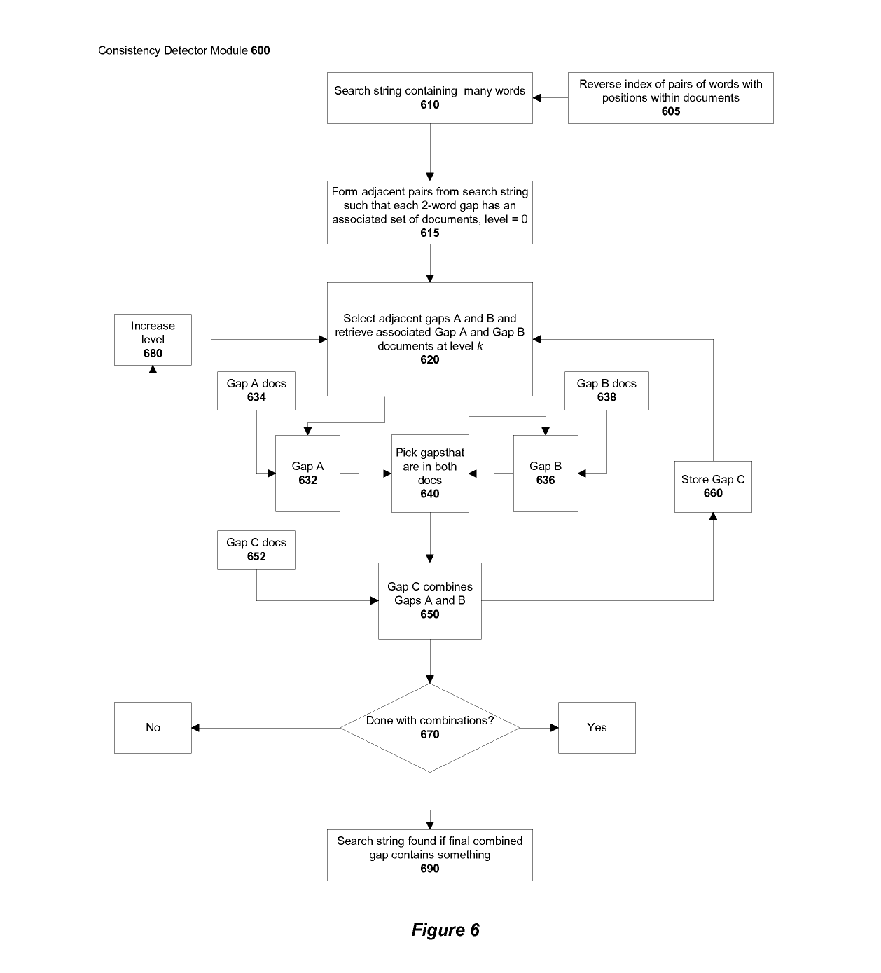

FIG. 6 shows one way to check for sequences of words. This procedure starts with two-word combinations and puts them together as long as they occur together somewhere.

Before searching for anything, the method prepares a reverse index of pairs of words in all documents in the collection (605). A reverse index entry for a pair of words stores both the documents where they occur and the positions within each such document.

A search string of n words can be made up of several adjacent pairs of words 610. We refer to this as a Gap in the diagram, the entire search string is the whole gap of n words. Break up this search string into adjacent pairs of words which are gaps of length 2. For each pair, find the associated reverse index information consisting of the documents and locations where the pairs of words occur (615). This forms the first step of an iterative process (620) that finds the documents containing increasingly longer sequences of words from the search string.

Suppose that A (632) followed by B (636) are two adjacent gaps (initially pairs) of words from the search string 610. Both A and B have associated set of documents Gap A docs (634) and Gap B docs (638). Using these sets of documents as well as positions within these documents, find out (640) the documents where A is immediately followed by B. This forms a new Gap C combining A and B (650) and also documents where A is followed immediately by B. After this step, test whether there are more combinations to be made (670).

Suppose it was not possible to form Gap C and the associated set of Gap C documents. In this case, there are no more combinations to be considered. In the check for this (670) the procedure exits because there are no more combinations that would work since Gap C which is a part of the whole sequence of search terms, is not contained in any document. Thus, the search string does not exist and this information is shown in the output (690).

If Gap C was found to have some documents, then this information is stored (660). When checking if we are done with combinations (670) the answer is “no”, hence the method increases the size of the gaps to be considered (680) and go back to (620) to consider further combinations. The stages of this process is described in FIG. 6 as “levels”. The size of the gaps considered doubles with each level, so there are no more than log(n) levels where n is the size of the search string in words and log is the logarithm with base 2.

### Correction of Detected Errors

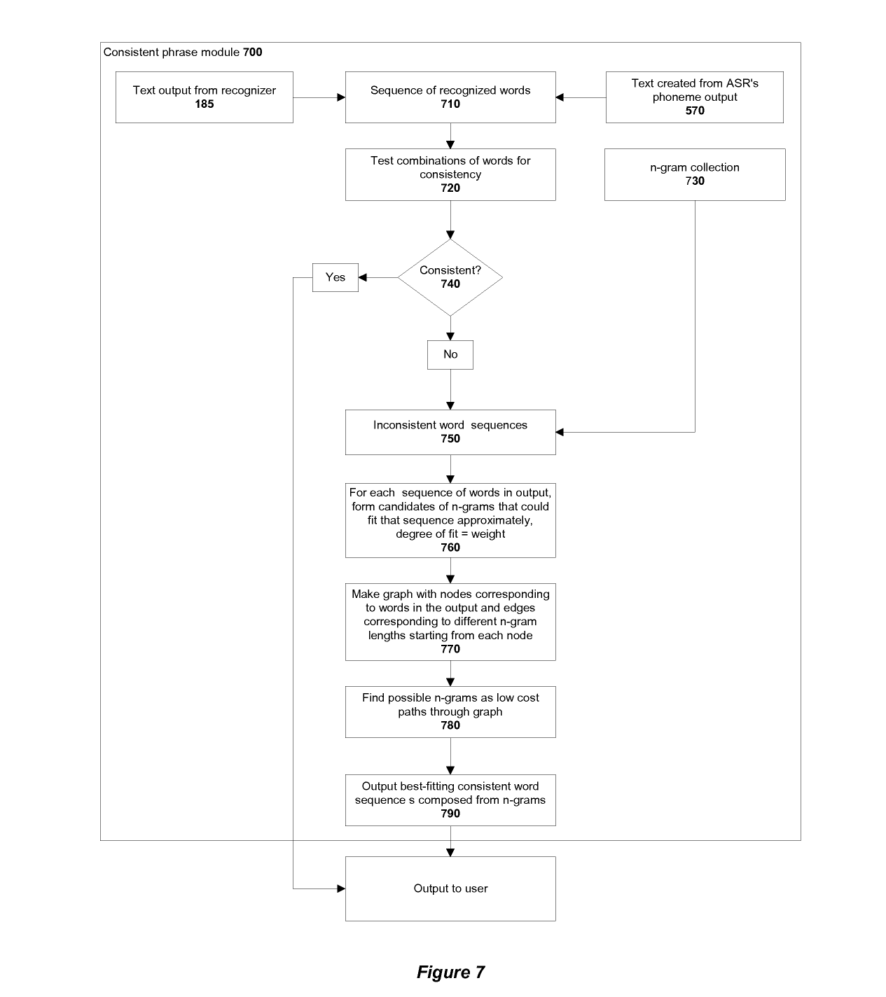

FIG. 7 shows the process of correcting errors. The figure uses the term “consistency” to mean that the string of words occurs in some document within the collection of documents in the language of the ASR system.

The input (185) to the correction method can come directly from an ASR system or from the sequence of phonemes that were converted to words by the process described in FIG. 5 (570). To check for errors (720), the method uses the procedure shown in FIG. 6 (740). If the search string is not found to have errors, it is output directly.

If errors are detected, then the process corrects the errors by replacing incorrect parts of the sequence of words 710 with sequences of words that occur in the language of the ASR. This is done using fixed length sequences of words (730) Sequences of n words are called n-grams. In an implementation, this collection may contain sequences of lengths 1, 2, 3, 4 and 5.

The sequence of words (750) is matched against all n-grams (730) to form a collection of sequences and associated n-grams (760). This procedure is similar to the procedure described in FIG. 5. If the sequence of output words 750 contains n words, the method forms a graph with n vertices (or nodes) and roughly n times n edges. Since the n-grams we consider have some maximum length k, for each node i, there are k−1 edges from that node. Each such edge is associated with an interval of words from 750.

As in FIG. 5, for each interval or associated edge, the method finds candidate n-grams and an associated weight (770). The weight is low if the words in the ngram fit the words in the interval.

Using this graph of nodes and weighted edges, as in FIG. 5, the method finds one or more low cost paths through the graph. Such a path corresponds to a sequence of n-grams from the language that can be put together to form an output (780).

After creating a sequence of words in this way, the method checks the output through the consistency checker. The sequences that are found to be inconsistent are rejected (790). The best-fitting consistent sequence of words is then sent to the output.

### Correcting Incomplete Phrases

The method described here creates combinations of words that occur in a specified language. These combinations do not have to be sentences. They also do not need to conform to grammatical rules of the language. Common ungrammatical phrases will be accepted by the consistency checker.

### Error Estimation

One method of estimating errors is to consider sum of three types of errors. The three types are insertion errors, deletion errors and substitution errors. An insertion error is where a word is incorrectly inserted into an otherwise correct sequence of words. Deletion errors are where a word is deleted from an otherwise correct sequence of word. A substitution (or replacement) error is one where a word is incorrectly replaced by another. Another estimate considers a replacement simply as a deletion followed by an insertion, thus counting a substitution error as two errors.

Alternate embodiments of error estimation may utilize other combinations of insertions, deletions and substitutions. The method described here can be applied regardless of the particular combination used to estimate errors.

### Using Search Engines for Consistency Checks

The consistency checker module 600 may be replaced with a standard search engine such as Google's. In this embodiment, phrases such as “the sheet under the edge of the night” are submitted as search terms as a single quoted phrase. Assuming that the submitted phrase, such as this example, is semantically incorrect, the search engine is likely to find only a few results, or none at all. The low number of results can be used as an alternate test to see if the phrase, generated from an ASR, is semantically correct.

Languages without Word Boundaries

Some languages, such as Mandarin Chinese, may not always write sentences as a sequence of words. Instead an entire sentence is written as a single sequence of characters. In this case, the method treats each character as a word.

### ASR Output in Multiple Languages

The method applies to ASR's that output words that belong to more than one language. To handle this situation, the method uses lists of sentences that may contain words from more than one language. The consistency checking module 600 and the error correcting module 700 work on this list of sentences as if it is made up of words from one language.

Correcting Errors that are Phonetically Close to Correct Output

Many ASR errors are words that are phonetically close to the correct ones. For example, “Please open your bag” may be incorrectly recognized as “Please open your back.” The words “back” and “bag” differ only in the last phoneme.

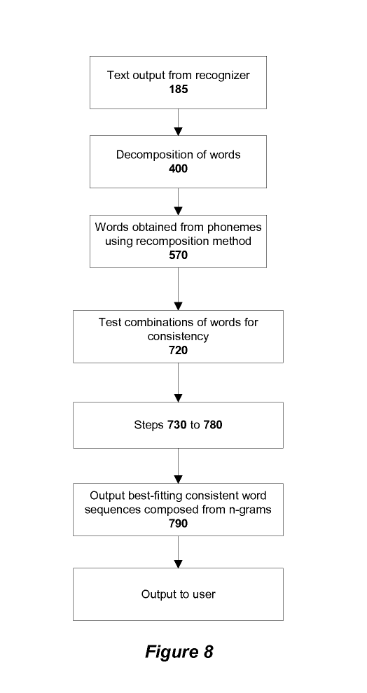

FIG. 8 illustrates one embodiment of the present invention that corrects such phonetically related errors. This combines modules from previous descriptions. In this embodiment, the ASR produces words as output 185. After obtaining this list of words, they are decomposed using the procedures in module 400. If the output from the ASR contains errors that are phonetically close to the intended words, then the correct words may be obtained by treating the output from 400 as phonetic output from an ASR. Words from this procedure are produced as described earlier in FIG. 5.

The procedure described for FIG. 5 produces a sequence of words 570. This is now treated as the input to the procedure described for FIG. 7. The output 570 enters the procedure in FIG. 7 as input 720. This input is checked for consistency, and the corrected output is processed through steps 730 to 780 to produce the output 790 as previously described for FIG. 7, and the result is output to the user.

Finding the Correct Sentence from a List

In many situations, an ASR is expected to recognize sentences from a large list of acceptable sentences. For example, voice command systems usually require the user to say one of many phrases; an unambiguous detection of the correct command is required to perform some task on a computer or other voice-controlled machinery.

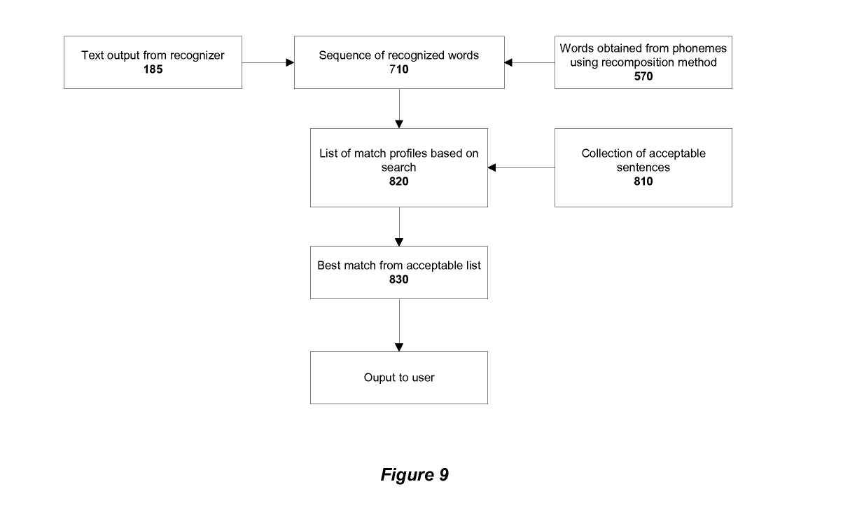

FIG. 9 illustrates one embodiment of the invention. The input for this embodiment may come directly from an ASR 185 or from words recognized from phonemes recognized by the ASR 570. Regardless of the original output from the ASR, this method works on sequences of words.

The correctly recognized sentence is expected to come from a list of sentences 810. The recognized words are compared (820) to each of these sentences. This creates an incremental search profile. The incremental search profile is the extent to which any sentence from the list 810 matches the words from 710 as more and more words are introduced. For example, the list 810 may contain only one sentence starting with the word “tuck” which starts the sentence “tuck the sheet . . . ” But if the recognized sequence 710 starts with the words “he” for instance as in “he is a tall man”, there may be several sentences that match the word “he”. However, as more words from 710 are added to the search, fewer and fewer sentences will match the introduced words. The best match 830 will be the sentence that matches this incremental search better than any other sentence by having more words in common and in the same order with the sequence from 710.

The method works even if the words in the list of sentences come from more than one language. The method uses the one list of sentences, regardless of whether the originating language of each word.

In one embodiment, this search can be performed using the longest common sub-sequence method well-known to those who are practiced in the art. The recognized sequence 710 is compared with each sentence in 810 to form the longest sub-sequence from 710 in each of the sentences. This will produce one version of an incremental search profile in 820. The best match is then selected by picking the sentence 830 from 810 that has the longest common sub-sequence with the sequence of words in 710. This best sentence 830 is then output to the user instead of the original output in 185.

The method also works if the sentences are not complete and grammatical. The method does not check grammar, and ungrammatical or incomplete sentences are treated the same as completed and grammatical sentences.

Correcting Phonetically Related Errors from a List

While ASR's produce errors, in many cases, the errors are words that have some phonetic relationship to the correct words.

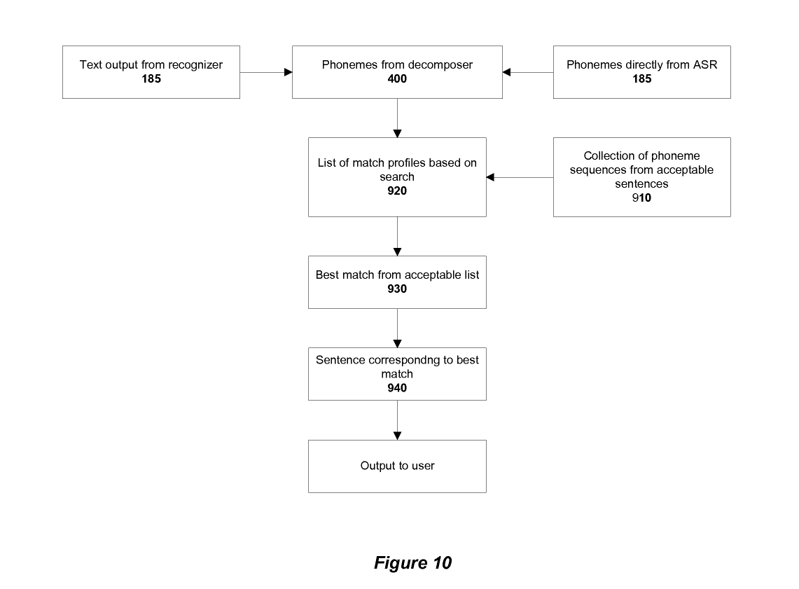

FIG. 10 illustrates another embodiment of the present invention where errors are phonetically related to correct results, and where the correct output comes from a list of acceptable sentences as in FIG. 9.

In this embodiment, the original input to the method is a set of words or a set of phonemes (185). If the input is a set of words, it is converted to phonemes using the decomposer module 400. If the input 185 is in the form of phonemes, then decomposition is not needed.

This embodiment converts the sentences that are to be recognized into sequences of phonemes 910. This may be done before starting any live correction, again using the decomposer module 400.

The sequence of recognized phonemes are compared to the sequences of correct phonemes 810 in 920. The best match of the phonemes from 400 and the phonemes from 910 is obtained through an incremental search profile as in step 820 of FIG. 9.

As in FIG. 9, the best match from the incremental search profile may be obtained using a longest common sub-sequence method. The longest common sub-sequence is found if man phonemes from 400 match phonemes from a sample sentence in 810 in the same order.

The best match from the incremental search profile is selected in 930. The sentence associated with this best match is then retrieved. This is output to the user instead of the original output 185.

### U S PATENT DOCUMENTS

US 20130054242 A1 Jonathan Shaw, Pieter Vermeulen, Stephen Sutton, Robert Savoie Reducing false positives in speech recognition systems
US 20060136207 A1 Sanghun Kim, YoungJik Lee Two stage utterance verification device and method thereof in speech recognition system
US 20110004473 A1 Ronen Laperdon, Moshe Wasserblat, Shimrit Artzi, Yuval Lubowich Apparatus and method for enhanced speech recognition
U.S. Pat. No. 6,064,957 A Ronald Lloyd Brandow, Tomasz Strzalkowski Improving speech recognition through text-based linguistic post-processing

### OTHER PUBLICATIONS

Vijay John, Phonetic Decomposition for Speech Recognition of Lesser-Studied Languages,
Proceeding of the ACM 2009 international workshop on Intercultural collaboration, Palo Alto, http://portal.acm.org/citation cfm?id=1499269

What is claimed is:

1. A method for improving speech recognition of an Automatic Speech Recognition System (ASR) comprising:
providing, on a non-transitory computer readable storage medium, a vocabulary comprising words from a specified language and their corresponding phonemes;
obtaining at least one sequence of phonemes generated by the ASR from at least one sentence spoken by a human user in a specified language into the ASR, the at least one sentence spoken by a human user comprising words occurring in the vocabulary;
comparing the at least one sequence of phonemes obtained from the ASR for each sentence with the phonemes for at least one spoken word in the vocabulary;
determining whether at least one error is present in the sequence of phonemes obtained from the ASR;
assigning contiguous phonemes obtained from the ASR for each sentence to words in the vocabulary;
producing at least one sequence of words from the assigned words in the vocabulary; and
correcting the at least one error, if present, in the sequence of phonemes obtained from the ASR
where the ASR is executed on a computer system with one or more processors.

2. The method as in claim 1 where the ASR generates sequences of words and where the words are converted to a sequence of phonemes.

3. The method as in claim 1 where the ASR generates at least one utterance that is an incomplete or ungrammatical sentence in the specified language.

4. The method as in claim 1 where the at least one error is determined using a formula using one or more of the following variables: the number of incorrectly inserted phonemes, the number of incorrectly deleted phonemes, and the number of incorrectly substituted phonemes.

5. The method as in claim 1 where the ASR generates sequences of phonemes that are written using non-roman characters.

6. The method as in claim 1 where the ASR generates phonemes belonging to a language where there are different tones for the same sound.

7. A method for improving speech recognition of an Automatic Speech Recognition System (ASR) comprising
providing, on a non-transitory computer readable storage medium, a vocabulary comprising words from a specified language and a collection of sentences of words;
obtaining at least one sequence of words generated by the ASR from at least one sentence spoken by a human user in a specified language, the at least one sentence spoken by a human user comprising words occurring in the vocabulary;
comparing the at least one sequence of words obtained from the ASR for each sentence with sequences of words that occur together in the collection of sentences;
determining whether at least one error is present in the sequence of words obtained from the ASR;
producing at least one sequence of words from the assigned words in the vocabulary; and
correcting at least one error, if present, in the sequence of words obtained from the ASR
where the ASR is executed on a computer system with one or more processors.

8. A method as in claim 7 where the at least one sequences of words generated by the ASR is generated where any sequence of five or less contiguous words occur together in the collection of sentences.

9. A method as in claim 7 where the ASR generates at least one utterance which is an incomplete or ungrammatical sentence in the specified language.

10. The method as in claim 7 where the at least one error is determined using a formula using one or more of the following variables: a number of incorrectly inserted words, a number of incorrectly deleted words, and a number of incorrectly substituted words.

11. The method as in claim 7 where a search engine is used to determine whether the at least one sequence of words obtained from the ASR occurs in the collection of sentences in the language.

12. The method as in claim 7 where the specified language is a language where sentences are not divided into words.

13. The method as in claim 7 where at least one sentence in the collection of sentences from the specified language contains one or more words in another language.

14. A method for improving speech recognition of an Automatic Speech Recognition System (ASR) comprising:
providing, on a non-transitory computer readable storage medium, a vocabulary comprising words from a specified language and a collection of sentences of words;
obtaining at least one sequence of words generated by the ASR from at least one sentence spoken by a human user in a specified language, the at least one sentence spoken by a human user occurring in the collection of sentences;
comparing the at least one sequence of words obtained from the ASR for each sentence with sequences of words that occur together in the collection of sentences;
determining a distance of at least one sequence of words obtained from the ASR with the sequence of words occurring in each sentence in the collection of sentences; and
obtaining from the vocabulary at least one sentence closest in distance to at least one sequence of words obtained from the ASR
where the ASR is executed on a computer system with one or more processors.

15. A method as in claim 14 where the ASR generates a sequence of phonemes that occur in one sequence of words, the one sequence of words being a sentence occurring in the collection of sentences.

16. A method as in claim 14 where the distance between the one sequence of words and the sequence of words in one sentence in the collection is calculated using a method that finds the common longest sub-sequence of the two sequences of words.

17. A method as in claim 14 where the collection of sentences include at least one sequence of words that may be an incomplete sentence in the language.

18. A method as in claim 14 where at least one sentence in the collection of sentences from the specified language contains one or more words in another language.
